(19) United States
(12) Patent Application Publication
(10) Pub. No.: US 2009/0045010 A1
(43) Pub. Date: Feb. 19, 2009

(54) DESCENDING DEVICE AND METHOD OF USE

(75) Inventor: Omar P. Jordan, Twinsburg, OH (US)

Correspondence Address: PEARNE & GORDON LLP, 1801 EAST 9TH STREET, SUITE 1200, CLEVELAND, OH, 44114-3108, US

(73) Assignee: Rit Rescue and Escape Systems, Twinsburgh, OH (US)

(21) Appl. No.: 12/192,601

(22) Filed: Aug. 15, 2008

Related U.S. Application Data
(60) Provisional application No. 60/956,016, filed on Aug. 15, 2007.

(51) Int. Cl. A62B 1/14; A62B 1/06; A62B 1/20

(52) U.S. Cl. 182/5; 188/65.4

(57) ABSTRACT

Provided is a descending device and method for controlling a rate of descent. The descending device includes a housing comprising a channel for receiving a tether along which the descending device is to travel during a descent. A cover conceals at least a portion of the serpentine pathway to minimize introduction of foreign bodies into the serpentine pathway. A first arcuate surface defines at least a portion of the serpentine pathway and a second arcuate surface defines at least another portion of the serpentine pathway. Each of the first and second arcuate surfaces includes a different radius of curvature. The descending device also includes at least one of a third arcuate surface adjacent to an entrance to the serpentine pathway and having a third radius of curvature that is shorter than both the first radius of curvature and the second radius of curvature, and a descent control lever to be manually actuated between a plurality of positions by the user to selectively control the rate of descent.

### CROSS-REFERENCE TO RELATED APPLICATIONS

This application claims the benefit of U.S. Provisional Application No. 60/956,016, filed Aug. 15, 2007, the entirety of which is incorporated herein by reference.

### TECHNICAL FIELD

This application relates generally to a device to control a rate of descent for an egress system and a method of using same.

### BACKGROUND OF THE INVENTION

Fire service, rock climbing, high angle rescue and technical rescue teams have utilized descending devices to create friction against a rope (or more recently a webbing) to allow for a controlled vertical descent. More recently, uses have been developed for personal emergency egress and self rescue from various heights. Emergencies can occur in almost any industry working from heights that would warrant self rescue or emergency escape. Ropes or webbing and their corresponding descending devices have grown smaller in size and shape to accommodate for personal use. One of the smallest diameter ropes or webbings certified by the National Fire Protection Association (NFPA) at the present time is about 7.5 mm or approximately 5/16″. Such small diameters can allow the ropes and webbings to be bent around arcuate surfaces having a small radius of curvature, requiring tighter bends in the descending device to create enough friction to control one's descent.

The use of such tight bends in descending devices to create enough friction for a controlled descent is not recommended for all types of ropes or webbing, however. Conventional egress systems, such as a support line with a harness for descending from burning buildings or descending from other high areas for other purposes have traditionally used rope or webbing formed from natural fibers. Natural fibers had the ability to stretch a substantial length when the rope or webbing was subjected to tensile forces; however, modern fibers have been developed with greater strength to minimize such stretching of the rope or webbing, and typically weigh less than the conventional natural fibers. Such new fibers can include manmade para-aramid fibers known by tradenames such as Kevlar, Twaron and/or Aramid fibers, for example, that tend to minimize stretching of the rope or webbing during use. But ropes or webbings made from such modern fibers perform better and have less of a tendency to form kinks when they extend over gradual bends, instead of tight binds, that may be used to create the desired amount of friction for a descent. Thus, descending devices including very sharp bends or kinks to create enough friction to slow a rate of feed of the rope, web, etc. through the descending devices may not be convenient for use with ropes, webbings, etc., made from such modern fibers.

Conventional descending devices also lack features that can help control the rate of descent during panic situations (where, for example, a user might grip a device too hard), or where the user may be disabled (and thus not be able to grip the device at all). Furthermore, prior art descending devices tend to require two hands to operate, typically one to operate the device, and the second to hold onto the rope, web, etc., especially during horizontal travel, such as toward a window, as the user tries to play out the rope, web, etc. The requirement of using two hands means that no hands are available for other important tasks, such as rescuing another person or carrying important equipment, for example

In addition, typical descending devices on the market for personal egress are open units, meaning the rope or webbing is substantially exposed, which can allow debris or unwanted elements to enter the device and affect its performance. And conventional descending devices are specific to left-handed and right-handed people, requiring a separate descending device for each, increasing equipment costs for rescue crews.

Finally, the NFPA continues to subject descending devices to more stringent functional requirements, requiring descending devices and the rope or webbing, etc. to be tested together in the configuration(s) in which they will be used. For example, one such test requires a 13.5 kN (3034 pounds) tensile test without failure of the rope, webbing for the descending device. The addition of this test has eliminated several manufacturers and multiple descending devices from the certified list.

Accordingly, there is a need in the art for a descending device that can be used in a descending system, such as an egress system, that overcomes one or more of these shortcomings, or that provides additional or different benefits and/or uses.

### BRIEF SUMMARY

According to one aspect, the present invention provides a descending device to be used by a user to control a rate of descent and a method of using the descending device. The descending device includes a housing comprising a channel for receiving a tether along which the descending device is to travel during a descent, the channel forming a serpentine pathway through the housing, wherein the serpentine pathway includes an aperture at each opposite end through which the tether can enter and exit the housing as the descending device travels along the tether. A cover is provided for concealing at least a portion of the serpentine pathway to minimize introduction of foreign bodies into the serpentine pathway, and a first arcuate surface defines at least a portion of the serpentine pathway and includes a first radius of curvature. Similarly, a second arcuate surface defines at least another portion of the serpentine pathway and includes a second radius of curvature, wherein the second radius of curvature is different than the first radius of curvature. The descending device further includes at least one of: a third arcuate surface adjacent to an entrance to the serpentine pathway and having a third radius of curvature that is shorter than both the first radius of curvature and the second radius of curvature, and a descent control lever to be manually actuated between a plurality of positions by the user to selectively control the rate of descent.

The descending device can optionally include first and second arcuate surfaces that have a suitable exposed surface area that, when the exposed surface area engages the tether, enough friction is created between the tether and the exposed surface area of the first and second arcuate surfaces to support at least 80% of a weight of the user. According to other embodiments, the friction created between the tether and the exposed surface area of the first and second arcuate surfaces supports at least 90% of the weight of the user.

According to another aspect, the present invention provides a descending device to be used by a user to control a rate of descent. The descending device according to the current aspect includes a housing comprising a channel for receiving a tether along which the descending device is to travel during a descent, and a cover for concealing at least a portion of the channel to minimize introduction of foreign bodies into the serpentine pathway. A descent control lever to be manually actuated between a plurality of positions by the user is provided to allow the user to selectively control the rate of descent. Said plurality of positions includes a first position actuated by strongly squeezing the lever, said first position stopping the rate of descent; a second position actuated by loosely or not squeezing the lever, said second position also stopping the rate of descent; and a third position between said first and said second position, said third position controlling the rate of descent determined by an amount of squeezing of the lever.

According to another aspect, the present invention provides a method of using a descending device as disclosed and claimed herein for descending down a building. The method includes the steps of providing the tether, providing the descending device with the tether wound therethrough, connecting one end of the tether to a fixed structure, connecting another end of the tether to a user, and the user rappelling down a side of a building or the structure by controlling the rate of descent by the user variably squeezing the lever.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1A shows a perspective view of a closed descending device according to an embodiment comprising a cover to at least partially conceal a serpentine pathway along which a tether extends through the descending device to create friction between the tether and the descending device;

FIG. 1B shows a perspective view of the descending device in FIG. 1A with the cover removed to reveal the pathway along which the tether extends;

FIG. 2 shows a perspective view of a descending device according to an embodiment comprising a cover and a descent control lever that can be actuated by a user with one hand to interfere with the ability of the tether to travel through the descending device;

FIG. 3 shows a perspective view of the descending device in FIG. 2 with the cover removed to illustrate cooperation between the lever and the tether to interfere with the ability of the tether to travel through the descending device, wherein the lever is oriented in an auto-locking position;

FIG. 4 shows a perspective view of the descending device in FIG. 2 with the cover removed to illustrate cooperation between the lever and the tether to interfere with the ability of the tether to travel through the descending device, wherein the lever is oriented in an anti-panic position;

FIG. 5 shows a perspective view of the descending device in FIG. 2 with the cover removed to illustrate the lever in a release position to allow the tether to travel through the descending device during a descent;

FIG. 6 shows a perspective view of an embodiment of a descending device comprising a descent control lever operatively coupled to adjust a position of a radius to selectively interfere with the ability of a tether to travel through the descending device; and

FIG. 7 shows a perspective view of an embodiment of a descending device comprising a linearly actuated descent controller to selectively interfere with the ability of a tether to travel through the descending device.

### DETAILED DESCRIPTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

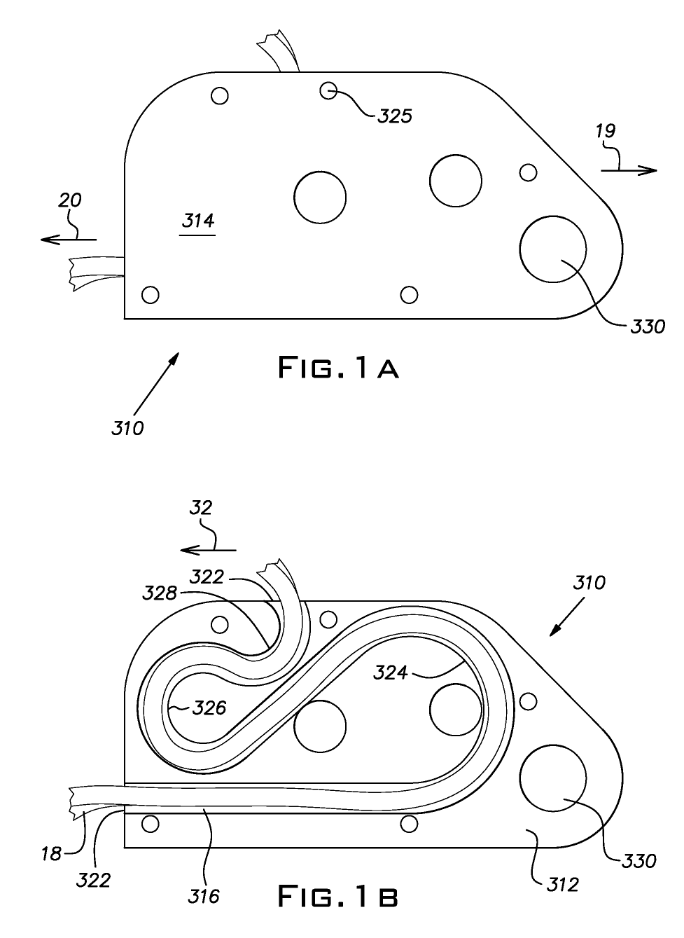

FIGS. 1A and 1B show an embodiment of a descending device 310 including a housing 312 and a cover 314 to conceal a winding channel forming a serpentine pathway 316 in which a tether 18 travels through the descending device 310 during a descent generally in the direction of arrow 19. During the descent the descending device 310 travels relative to the tether 18 in a direction such that the tether 18 passes through the serpentine pathway 316 and exits the top of the descending device 18 in a direction generally indicated by arrow 20.

The housing 312 can be formed from any suitably strong and durable material such as aircraft-grade aluminum, plastic materials, other metals, or any combination thereof. The housing 312 can be a block of the material, with sufficient thickness to allow the serpentine pathway 316 to be recessed a suitable depth into the surrounding material to receive the tether 18. When the cover 314 is removably coupled in place to the housing 312 by fasteners 325 such as screws, rivets, and the like, the recessed serpentine pathway 316 can extend between the cover 314 and a side of the housing 312 opposite the cover 314, thereby forming a substantially enclosed interior passage through the descending device 310. According to such an arrangement access to the substantially enclosed interior passage is limited, without removing the cover 314, to apertures 322 in the housing 312 through which the tether 18 can enter and exit the descending device 310. The cover 314 also minimizes the introduction of debris and foreign bodies into the serpentine pathway 316, and maintains the tether 18 within the serpentine pathway 316.

The tether 18 can be any rope, webbing and the like formed of any suitably-strong material, and optionally approved for use by the NFPA to elongate less than a comparable tether formed from natural fibers when subjected to the same tensile force. Changes in egress systems are necessary due to the properties of new fibers, such as Kevlar from which the tether 18 can be formed. Aramid or para-aramid fibers (including Kevlar, Technora, Twaron, Twarain, Spectra etc.) have little or very limited elongation tolerance. Conventional descending devices include sharp corners (radii) that contact the tether in order to provide enough friction to stop relative travel between the descending device and tether 18. A tether 18 formed from Arimid fibers, for example, because it exhibits such limited elongation must contact and go around these sharp radii to allow for enough fiber to be effected by the pull of the rope or webbing.

The serpentine pathway 316 includes a plurality of arcuate surfaces, referred to herein as first and second radii 324, 326, each including a tether engaging surface that contacts the tether 18 and over which the weight (or tensile force) on the tether 18 is distributed to limit the rate of descent. Distributing the force imparted on the tether 18 over the plurality of the gradually arcuate radii 324, 326 minimizes the use of tight bends (i.e., arcuate surfaces with a small radius of curvature that could damage the tether when subjected to the tensile forces to be experienced during a descent) that would otherwise be required to create enough friction between the descending device 310 and the small-diameter tether 18 comprising synthetic fibers to stop a descent. The distribution of force exerted by the tether 18 over the plurality of radii 324, 326 is not necessarily (although it optionally can be) equal.

For example, if the tether 18 is a rope (or in some embodiments a flat webbing), the first radius 324 can support about 60% of the force (weight) on the rope, and can have a circumference shape, or radius of curvature, comparable to a circle with a diameter that is approximately 11 times the diameter of the rope (or thickness of the webbing) to allow for 95-100% of tensile force on the rope to be supported thereon without subjecting the rope to damage from a tight bend. The second radius 326 in the present example can have a circumference shape, or radius of curvature, comparable to a circle with a diameter that is approximately 5 times the diameter of the rope to support most of the remainder of the force/weight on the rope. Thus, at least one of the first and second radii 324, 326 has a radius of curvature that is different than that of the other of the first and second radii 324, 326.

The friction between the plurality of gradually arcuate radii 324, 326 and the rope offsets a significant majority portion of the weight (tensile force) on the tether 18, such as between 80-100% of the weight (tensile force), but according to alternate embodiments, can optionally bear less than 100% of the weight (tensile force) on the rope. The minor portion of the overall weight (tensile force) on the rope can be accounted for by friction between the rope and a small radius 328. For example, after the second radius 326 (i.e., closer to the aperture 322 through which the rope enters the descending device 310 than the second radius 326), the remaining amount of force/weight to be supported by the rope to stop a descent is small enough to allow the use of a small radius 328, which can optionally have a radius of curvature much closer to the radius of curvature of the rope than the smaller of the first and second radii 324, 326. According to other embodiments, the small radius 328 can even have a radius of curvature that is less than the radius of curvature of the rope without subjecting the rope to damage when offsetting the remaining weight (tensile force) with friction between the small radius 328 and rope. In addition to creating friction, the small radius 328 also aligns the tether 18 entering the descending device 310 during a descent.

In use, the embodiment of the descending device 310 shown in FIGS. 1A and 1B is coupled to the tether 18 such that the tether 18 extends through the serpentine pathway 316 of the housing 312. The descending device 310 is also coupled to a user by attaching one end of a fastener (such as a carabiner, clip, knot, buckle, etc . . . ) to an aperture 330 or other suitable receiver formed in the housing 312 and the other end of the fastener to the user. Once secured to the descending device 310, the user is basically suspended from the descending device 310 to descend under the force of gravity in the general direction of arrow 19. With the user's weight supported by the descending device 310, the user can lift a portion of the tether 18 adjacent the aperture 322 into which the tether 18 passes as the descending device 310 travels along the tether 18 in the general direction of arrow 32 to engage the small radius 328 with tether 18. The friction created between the tether 18 and the small radius 328, in combination with the friction created between the first and second radii 324, 326 and the tether 18, prevents the descending device 310 from traveling along the tether 18, and accordingly, maintains the user's altitude and prevents the user from descending.

To descend, the user can lower the altitude of the portion of the tether 18 adjacent the aperture 322 into which the tether 18 passes as the descending device 310 descends along the tether 18 in the general direction opposite of arrow 32. So lowering that portion of the tether 18 disengages the small radius 328 from tether 18, and minimizes the friction between those two features. With the tether 18 disengaged from the small radius 328, the descending device 310, and accordingly the user coupled thereto, can descend along the tether 18. To slow the rate of descent, the portion of the tether 18 adjacent the aperture 322 into which the tether 18 passes as the descending device 310 descends along the tether 18 can again be elevated in the general direction of arrow 32, but to a lesser extent than required to fully engage the small radius 328 with the tether 18 and completely stop the descent.

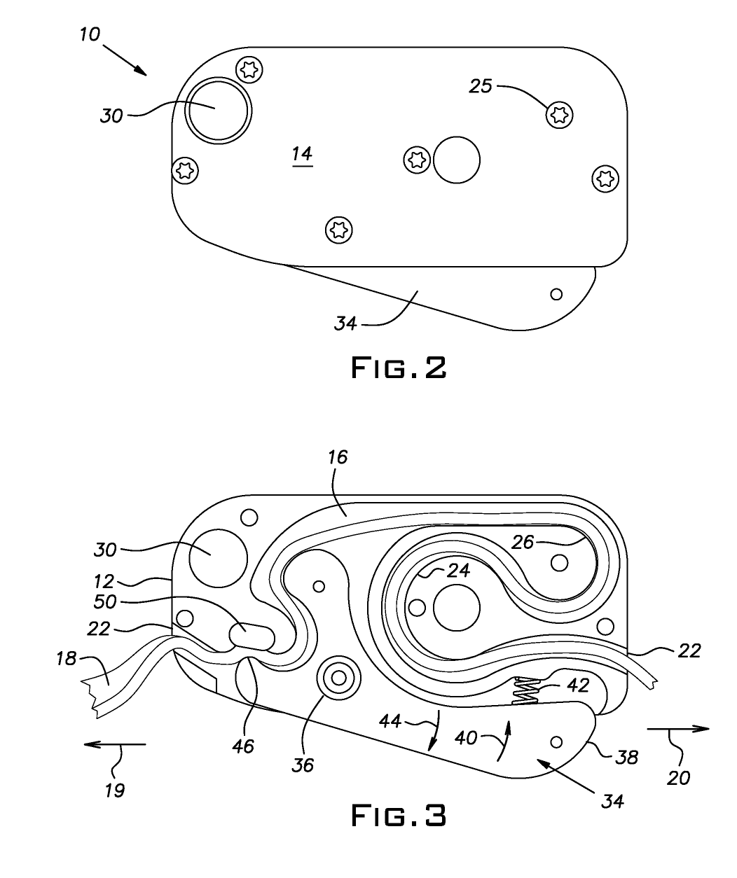

Another embodiment of the descending device 10 is shown in FIGS. 2-5. Similar to the descending device 310 in FIG. 1, the descending device 10 shown in FIG. 2 comprises a housing 12 (FIG. 3) provided with a cover 14 to minimize the introduction of debris and other foreign bodies into the interior of the descending device 10. A hand-actuated descent control lever 34, also referred to simply as lever 34, is provided to allow the user to single handedly control the rate of descent, and to minimize uncontrolled descents resulting from the incapacity of the user, panic, or a combination thereof.

In FIG. 3 the cover 14 of the descending device 10 in FIG. 2 has been removed to expose the interior of the descending device 10. As shown, the descending device 10 comprises a housing 12 in which a serpentine pathway 16 is formed to permit the tether 18 to travel through the descending device 10 during a descent. The descending device 10 again includes a plurality of arcuate surfaces referred to as first and second radii 24, 26 defining at least two portions of the serpentine pathway 16. Friction between the tether 18 and these radii 24, 26 will offset a majority of the weight (tensile force) on the tether 18 during a descent. Furthermore, the descending device 10 can be a closed system by providing a cover 14, and thus only having apertures 22 for the tether 18 to pass through the descending device 10, thereby protecting the interior of the device from dirt and reducing the likelihood of pinching the user, for example. The first and second radii 24, 26 can also optionally have the same, or a similar sizes relative to the tether 18 and each other as discussed above.

The embodiment shown in FIG. 3 also includes a descent control lever 34 that can be manipulated by the user to control the rate of descent. The descent control lever 34 also minimizes uncontrolled descents resulting from the incapacity of the user, panic on the part of the user, or a combination thereof. The lever 34 is pivotally coupled to the housing 12 by a pivot pin 36, and can be manipulated by the user to manually adjust the friction between the descending device 10 and the tether 18. One end, referred to as the “handle end” 38, of the lever 34 can be gripped and squeezed by the user to rotate the handle end 38 of the lever 34 about the pivot pin 36 in the direction indicated by the arrow 40 towards the housing 12. When the user releases his grip on the handle end 38 of the lever 34, a spring 42 biases the handle end 38 of the lever 34 away from the housing 12 in the opposite direction about the pivot pin 36, as indicated by arrow 44. The lever 34 and housing 12 of the descending device 10 are arranged to minimize the extent to which the lever 34 protrudes from the housing 12 to minimize portions that could catch clothing, gloves, debris, etc . . . during a descent. As shown in FIG. 2, the lever 34 can be arranged so that it does not completely protrude from the housing 12 at any point.

Inclusion of the lever 34 allows the user to control the rate of descent with a single hand, freeing up the other hand for other purposes as there is no need to guide, lift or otherwise control the portion of the tether 18 entering the descending device 10 to control the rate of descent. The lever 34 can also optionally stop the descent should a user become unconscious or incapacitated, or panic and grip the lever 10 too hard, as discussed herein. Once the descent has stopped, the user can squeeze the lever once again as described in detail below and the friction on the tether 18 is sufficiently relieved to allow the vertical descent to continue.

FIG. 3 shows the descending device 10 in a state wherein the lever 34 is in what is referred to herein as an “auto-locking” position. The lever 34 has been released from the grip of the user, and the spring 42 has urged the lever 34 to pivot about the pivot pin 36 in the direction of arrow 44. Additionally, the weight (tensile force) of the user on the tether 18 causes the tether 18 to act on, and creates between the tether 18 and a panic pincer 48 portion of the lever 34, which also strongly urges the lever 34 to rotate in the direction of arrow 44 about the pivot pin 36 to the auto-locking position when the lever 34 is released by the user. With the lever 34 in the auto-locking position a locking pincer 46 portion of the lever 34 pinches the tether 18 against a substantially-elastically-deformable pad 50 provided to the housing 12, as shown in FIG. 3. The pad 50 can be formed from any suitable material that, when contacted by the tether 18 under the force of the locking pincer 46 in the auto-locking position, creates sufficient friction to substantially limit the rate of descent to a rate slower than free-fall conditions under the weight of the user, and optionally to completely stop the descent. The material from which the pad 50 can be formed can also optionally include fire-resistant qualities. An examples of a suitable material from which the pad 50 can be formed is Viton®, which is a fluoroelastomer from DuPont Performance Elastomers that is a fire-rated extruded rubber material with heat resistance upwards of 400° F. Accordingly, the urging of the lever 34 to the auto-locking position in response to the user's release of his grip from the lever 34 minimizes the likelihood of allowing the user to free fall in the event the user becomes incapacitated or otherwise releases the lever 34.

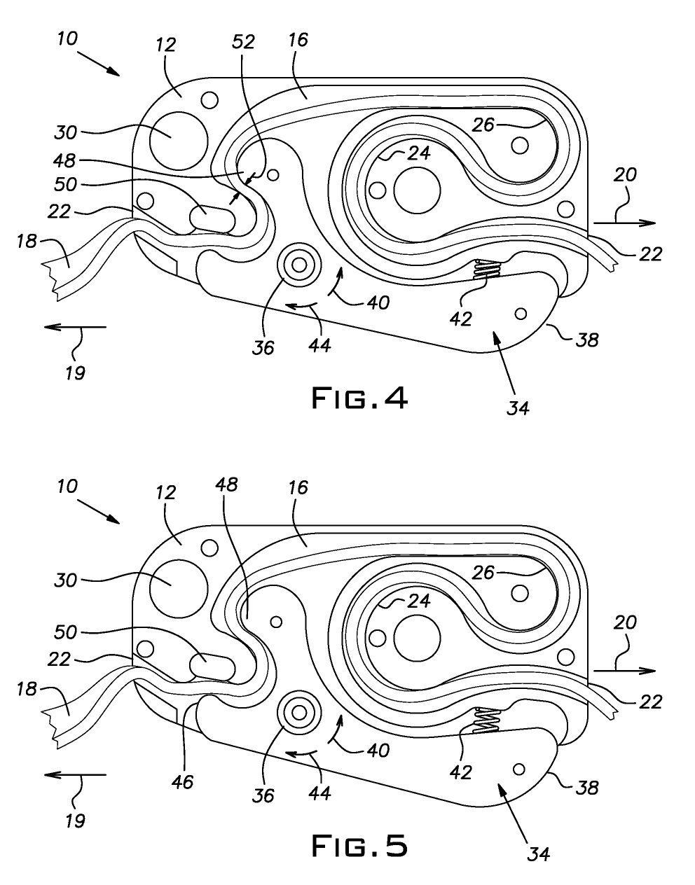

The lever 34 shown in the embodiment appearing in FIG. 3 can also optionally include a panic feature that can limit the rate of descent in the event that the user panics during the descent and subconsciously squeezes the lever 34 too hard. Under panic conditions the user is unlikely to be able to release the grip on the lever 34 when trying to regain control of an uncontrolled descent. In fact, the user is likely to squeeze harder as the level of panic increases. Should a user panic and try to hold on too tightly and inadvertently squeeze the lever 34 too hard, this will cause the lever 34 to overcome the force of the spring 42 and pivot about the pivot pin 36 in the direction of arrow 40 towards the housing 12 as shown in FIG. 4. The descending device 10 is shown in FIG. 4 with the lever 34 in what is referred to herein as a “panic” position, which can result from the user exerting too much pressure, such as when panicking for example.

To eliminate the possibly counter-intuitive requirement that the user gradually release his grip to slow the rate of descent, when the user squeezes the handle end 38 of the lever 34 with excessive force the lever 34 rotates about the pivot pin 36 to the panic position of FIG. 4. With the lever 34 in the panic position, the panic pincer 48 portion exerts pressure against the tether 18, and pinches the tether against the housing 12 as shown by arrows 52, or optionally against a friction pad (not shown) similar to pad 50, to create enough friction on the tether 18 to substantially limit the rate of descent to a rate slower than free-fall conditions under the weight of the user, and optionally to completely stop the descent.

In addition to the auto-locking and panic positions, the lever 34 can also be manually adjusted by the user to what is referred to herein as a “descent” position, which is shown in FIG. 5. With the lever 34 manually adjusted by the user to the descent position, neither the locking pincer 46 nor the panic pincer 48 pinches the tether 18 against the housing 12 or optional pad 50 to create sufficient friction against the tether 18 to stop the descending device 10 from descending down the tether 18 under the weight (tensile force) imparted on the tether 18 by the user. The locking pincer 48 or the panic pincer 48 may partially pinch the tether 18 against at least one of the housing 12 and the optional pad 50 based on the force applied by the user squeezing the lever 34 to control the rate of descent, as desired by the user. However, this pinching of the tether 18 would not be of such force to create enough friction to stop the user from continuing his descent, unless the user sufficiently releases his grip or sufficiently squeezes his grip to activate the corresponding alternate pinching functions discussed herein. The force applied by the user in squeezing or otherwise manually adjusting the position of the lever 34 can be infinitely variable between the auto-locking position and the panic position, resulting in an infinitely variable rate of descent between free fall and stop.

In use, the embodiment of the descending device 10 in FIGS. 2-5 will enable the user to manually control the rate of descent with a single hand since the user is suspended from the descending device 10. If the user becomes incapacitated or otherwise must let go of the lever 34 completely, the tether 18 will contact the panic pincer 48 portion of the lever 34. The friction created between the tether 18 and panic pincer 48, along with the force imparted by the spring 42, will pivot the lever 34 about the pivot pin 36 in the direction of arrow 44 toward the auto-lock position. In the auto-lock position, the locking pincer 46 of the lever 34 will compress the tether 18 against housing 12, or optionally the pad 50. When the lever 34 is in the auto-locking position as shown in FIG. 3, it significantly slows the rate of descent to a rate that is much slower than the rate of descent of the user under free-fall conditions, and optionally stops the descent completely.

On the other hand, if the user panics while descending and excessively squeezes the handle end 38 of the lever 34, this will cause the lever 34 to pivot about the pivot pin 36 in the direction of arrow 40 to the panic position shown in FIG. 4. With the lever 34 in the panic position, the tether 18 is compressed between the panic pincer 48 and the housing 12 or optional friction pad (not shown), which can be similar to the pad 50. This compression creates enough friction between the housing 12 or optional friction pad to significantly slow the rate of descent to a rate that is much slower than the rate of descent of the user under free-fall conditions, and optionally stops the descent completely.

Under normal operating conditions, the user can moderately adjust his grip on the handle end 38 of the lever 34 to adjust the lever to a position between the two extremes of the auto-lock position and the panic position. With the lever 34 adjusted between those extremes, the user can vary the rate of descent to a desired speed to allow for a controlled descent under the circumstances. This can be done by the user with one hand since there is no need to hold the tether 18 near the inlet aperture 22 to the descending device 10 during descent or horizontal travel. Thus, a single hand can operate the descending device 10, leaving his other hand free to tend to other matters. Furthermore, since the descending device 10 lacks features specific to either right-handed or left-handed users, the descending device 10 allows the user to control the descent with either hand without re-orienting the device, allowing for ambidextrous operation.

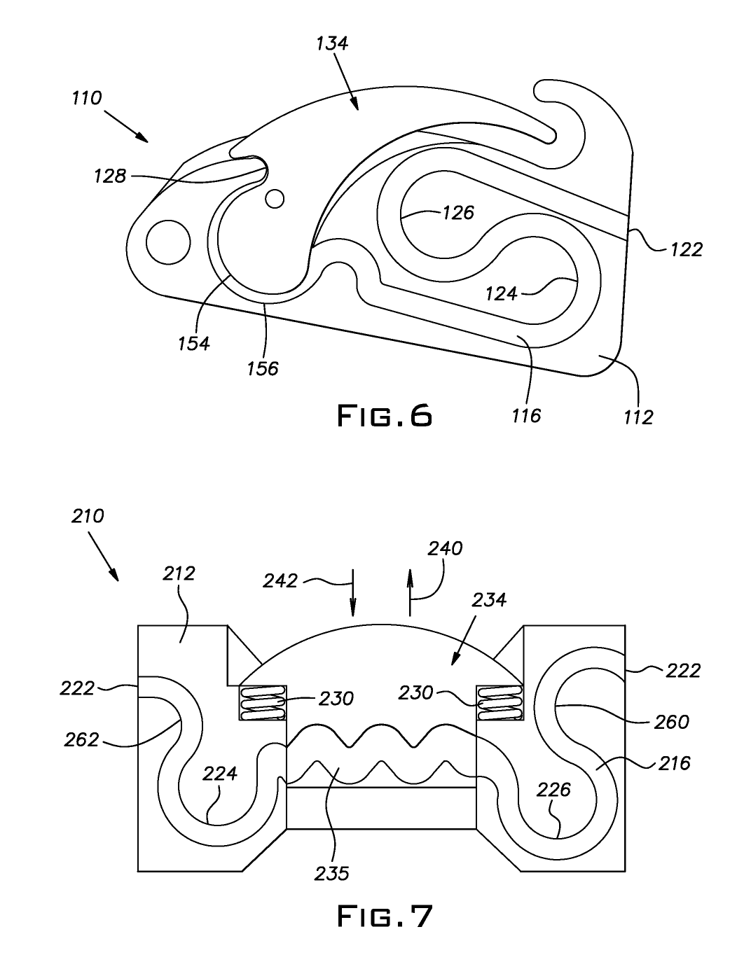

FIG. 6 illustrates an embodiment of a descending device 110 comprising a descent control lever 134 operatively coupled to adjust a position of an additional radius 154, in addition to the first and second radii 124, 126, instead of pincers 146, 148 to control the rate of descent. As shown, the additional radius 154 is integrally formed at a distal end of the lever 134. Pivoting of the lever 134 about a pivot pin (not shown) similar to that described above can selectively cause the additional radius 154 to compress the tether 18 against an opposing surface 156 defining a portion of the serpentine pathway to interfere with the ability of a tether 18 to travel through the descending device 110.

FIG. 7 shows yet another embodiment of a descending device 210 comprising a descent control lever 234, but this lever 234 is linearly actuated instead of pivotally coupled to the housing 212. According to such an embodiment, the housing 212 again defines a channel defining a serpentine pathway 216 through which the tether 18 can travel through the descending device 210 during a descent. The serpentine pathway 216 also includes the first and second radii 224, 226, but additionally includes third and fourth radii 260, 262 that can be larger, smaller or the same size as the first or second radii 224, 226. Between opposite ends of the housing 212 is the linearly-actuated lever 234 that is also adjustable between auto-lock, panic and descent positions. One or more springs 230 urge the lever 234 outwardly, generally away from the housing 212 in an unbiased state.

The lever 234 defines a channel that also forms its own serpentine pathway 235 that is selectively alignable with the serpentine pathway 216 formed in the housing 212. Alignment between the serpentine pathway 235 formed in the lever 234 and the serpentine pathway 216 formed in the housing 212 can be accomplished by the user manually adjusting the lever 234 between an auto-lock position and a panic position. In the auto-lock position the user has completely released his grip on the lever 234, thereby allowing the spring(s) 230 to adjust the lever 234 outwardly, away from the housing 212 in the direction of arrow 240 to the auto-lock position. With the lever 234 adjusted to the auto-lock position, the serpentine pathway 235 formed in the lever 234 is misaligned with the serpentine pathway 216 formed in the housing 212, thereby interfering with the ability of the tether 18 to pass through the descending device 210, and slowing the rate of, or optionally stopping the descent.

Similarly, to place the lever 234 in the panic position the user has excessively squeezed the lever 234, thereby adjusting the lever 234 inwardly, towards the housing 212 in the direction of arrow 242 to the panic position. With the lever 234 adjusted to the panic position, the serpentine pathway 235 formed in the lever 234 is misaligned with the serpentine pathway 216 formed in the housing 212, thereby once again interfering with the ability of the tether 18 to pass through the descending device 210, and slowing the rate of, or optionally stopping the descent.

A controlled descent at a desired rate can be accomplished by the user manually adjusting the lever 234 between the extreme positions of the auto-lock position and the panic position. The greatest rate of descent can be accomplished by perfectly aligning the serpentine pathway 235 formed in the lever 234 with the serpentine pathway 216 formed in the housing 212, as shown in FIG. 7.

The examples of descending devices discussed herein and other embodiments can be specifically adapted for use for rope, webbing or any other desired tethers by adapting the thickness of the channel forming the serpentine pathway through the descending devices, and establishing suitable pincer clearance relative to the housing or optional pad(s) to account for the thickness of the desired tether.

According to alternate embodiments, the descending devices and other embodiments can optionally include a pivot pin comprising a self-oiling bushing for the lever. The overall descending device can be relatively thin, and can optionally be slightly thicker than the width of the tether it is to be used with. Depending on the tether, the thickness of the descending devices could approach slightly more than about half an inch, and optionally less than one inch. Further, the descending devices disclosed herein could be used with just about any egress system, such as any of those shown in U.S. Pat. Nos. 7,086,091, 6,487,725, and 5,970,517, which are hereby incorporated in their entirety by reference.

Basically, one method of using the descending devices includes attaching one end of the tether to a structure, such as a door or window in a building, (for example, by using a hook, knot, carabiner, etc . . . ) and the second end is typically removably attached (such as by using a carabiner, clip, knot, buckle, etc.) to a harness or belt worn by the rescue worker (or other user of an egress system). Any required additional length portions of the tether 18 for the descent can be held in a cartridge, module, or other device that might be worn or held by the user, such as those provided in the referenced patent applications that were incorporated by reference (see, for example, U.S. Pat. No. 7,086,091). Useful harnesses and belts that could be utilized for this operation are also disclosed in those referenced patent applications. SCBAs may also be attached to the harness/belt, as also discussed in one of those references.

The descending device examples can also optionally be removably attached to the harness (or some other part) of the user (such as via a carabiner, or a strap and carabiner combination, for example), to aid in a rescue (or other descending) operation. The user can then use either hand to hold the descending devices while freeing up the second hand for other purposes (such as to hold a person being rescued, for example). Conventional solutions typically require the second hand to hold the support line during a descending operation. The user can use either hand without changing the orientation of the device, thus making the device ambidextrous.

The user can optionally move horizontally by pulling on the descending devices and leaning back to put a portion of his weight onto the tether, and, if necessary, putting some pressure on the lever to reduce any friction imparted on the tether and allow the tether to play out of the descending devices. Then, the user can descend vertically by putting pressure on the lever to allow the tether to play out, using his weight to descend. Too much pressure on the lever will cause the descent to slow down, eventually stopping the descent if the user panics and squeezes the lever very hard, whereas releasing all pressure will also cause the descent to slow, and optionally stop. Thus, the user can control his descent speed using the descending device examples. Accordingly, the descending devices can support the rescue, or other descent operations.

The invention has been described hereinabove using specific examples and embodiments; however, it will be understood by those skilled in the art that various alternatives may be used and equivalents may be substituted for elements and/or steps described herein, without deviating from the scope of the invention. Modifications may be necessary to adapt the invention to a particular situation or to particular needs without departing from the scope of the invention. It is intended that the invention not be limited to the particular implementations and embodiments described herein, but that the claims be given their broadest interpretation to cover all embodiments, literal or equivalent, disclosed or not, covered thereby.

What is claimed is:

1. A descending device to be used by a user to control a rate of descent, the descending device comprising:
a housing comprising a channel for receiving a tether along which the descending device is to travel during a descent, the channel forming a serpentine pathway through the housing, wherein the serpentine pathway includes an aperture at each opposite end through which the tether can enter and exit the housing as the descending device travels along the tether;
a cover for concealing at least a portion of the serpentine pathway to minimize introduction of foreign bodies into the serpentine pathway;
a first arcuate surface defining at least a portion of the serpentine pathway and including a first radius of curvature;
a second arcuate surface defining at least another portion of the serpentine pathway and including a second radius of curvature, wherein the second radius of curvature is different than the first radius of curvature; and
at least one of:
a third arcuate surface adjacent to an entrance to the serpentine pathway and having a third radius of curvature that is shorter than both the first radius of curvature and the second radius of curvature, and
a descent control lever to be manually actuated between a plurality of positions by the user to selectively control the rate of descent.

2. The descending device according to claim 1, wherein the cover is removably coupled to the housing by one or more fasteners.

3. The descending device according to claim 1, wherein the first radius of curvature has a circumference corresponding to a circumference of a circle having a diameter that is about 11 times larger than a dimension of the tether.

4. The descending device according to claim 1, wherein the second radius of curvature has a circumference corresponding to a circumference of a circle having a diameter that is about 5 times larger than a dimension of the tether.

5. The descending device according to claim 1, wherein the first and second arcuate surfaces have an exposed surface area that, when the exposed surface area engages the tether enough friction is created between the tether and the exposed surface area of the first and second arcuate surfaces to support at least 80% of a weight of the user.

6. The descending device according to claim 5, wherein the friction created between the tether and the exposed surface area of the first and second arcuate surfaces supports at least 90% of the weight of the user.

7. The descending device according to claim 1, wherein the descending device comprises the descent control lever to be manually actuated by the user to selectively control the rate of descent, wherein
the descent control lever comprises at least one of:
a locking pincer that is operable in response to a release of the descent control lever by the user to engage the tether within the descending device and interfere with the descent of the descending device along the tether, and
a panic pincer that is operable in response to an excessive force being exerted by the user on the descent control lever to engage the tether within the descending device and interfere with the descent of the descending device along the tether.

8. The descending device according to claim 7, wherein engagement between at least one of the locking pincer and the panic pincer stops the descent of the descending device along the tether.

9. The descending device according to claim 7 further comprising a substantially elastically-deformable pad coupled to the housing, wherein at least one of the locking pincer and the panic pincer engages the tether by pressing the tether against the pad to interfere with the descent of the descending device along the tether.

10. A descending device to be used by a user to control a rate of descent, the descending device comprising:
a housing comprising a channel for receiving a tether along which the descending device is to travel during a descent;
a cover for concealing at least a portion of the channel to minimize introduction of foreign bodies into the serpentine pathway; and
a descent control lever to be manually actuated between a plurality of positions by the user to selectively control the rate of descent, wherein said positions include a first position actuated by strongly squeezing the lever, said first position stopping the rate of descent, a second position actuated by loosely or not squeezing the lever, said second position also stopping the rate of descent, and a third position between said first and said second position, said third position controlling the rate of descent determined by an amount of squeezing of the lever.

11. The descending device according to claim 10, wherein the channel forms a serpentine pathway through the housing, wherein the serpentine pathway includes an aperture at each opposite end through which the tether can enter and exit the housing as the descending device travels along the tether.

12. The descending device according to claim 11, further comprising:
a first arcuate surface defining at least a portion of the serpentine pathway and including a first radius of curvature; and
a second arcuate surface defining at least another portion of the serpentine pathway and including a second radius of curvature, wherein the second radius of curvature is different than the first radius of curvature.

13. The descending device according to claim 10, further comprising:
a first arcuate surface defining at least a portion of the serpentine pathway and including a first radius of curvature; and
a second arcuate surface defining at least another portion of the serpentine pathway and including a second radius of curvature, wherein the second radius of curvature is different than the first radius of curvature.

14. A method of using the descending device of claim 10 for descending down a building, said method comprising the steps of:
providing the tether;
providing the descending device with the tether wound therethrough;
connecting one end of the tether to a fixed structure;
connecting another end of the tether to a user;
the user rappelling down a side of a building or the structure by controlling the rate of descent by the user variably squeezing the lever.

15. The method according to claim 14, further comprising the step of connecting the descending device to the user.

16. The method according to claim 14, wherein the tether is comprised of a minimally stretchable synthetic material.

17. The method according to claim 16, wherein said material includes one or more of Kevlar, Twaron and/or Aramid fibers.
